(19) United States
(12) Patent Application Publication
(10) Pub. No.: US 2025/0304125 A1
(43) Pub. Date: Oct. 2, 2025

(54) BRAKE ASSEMBLY FOR A VEHICLE

(71) Applicant: Transportation IP Holdings, LLC, Norwalk, CT (US)

(72) Inventor: Anthony James Turnbull, Wetherill Park (AU)

(21) Appl. No.: 18/617,119

(22) Filed: Mar. 26, 2024

(51) Int. Cl. B61H 7/00; B61H 1/00

(52) U.S. Cl. CPC B61H 7/00; B61H 1/00

(57) ABSTRACT

A braking assembly for a vehicle is provided and can include a braking element having an arcuate body. The braking element can include a first lobe extending from the arcuate body and having a first braking surface configured to engage a tread of a wheel, and a first non-braking surface portion adjacent the first lobe configured to not engage the tread of the wheel. The braking element can also include a second lobe extending from the arcuate body that may be spaced and offset from the first lobe, the second lobe having a second braking surface configured to engage the tread of the wheel, and a second non-braking surface portion adjacent the second lobe and diagonal to the first non-braking surface portion, the second non-braking surface portion configured to not engage the tread of the wheel.

### BACKGROUND

### Technical Field

The subject matter described relates to a brake assembly for a vehicle.

### Discussion of Art

Vehicle systems, such as rail vehicles, utilize braking assemblies to stop the vehicle system. Traditionally, the braking element that engages the tread of the wheel has an arcuate body to conform to the shape of the wheel and has a friction surface that engages the tread of the wheel. This friction surface generally has a rectangular cross-section and is simply a block of material. Multiple blocks are sometimes used on the same wheel. Some blocks are divided into two elements by cutting or moulding a slot around the block center with each element covering the majority of the tread surface width. This block braking element tends to create significant variances in temperatures across the tread and around the circumference of the wheel resulting in hot spots at certain locations of the tread during braking. These hot spots over time result in deformations, additional wear, and reduce the life of the wheel. In particular, thin wheel treads can be prone to thermal distortion resulting in acceleration of friction material wear via hot zone formation on the rim and flange side of the tread. As a result, it may be desirable to have a system and method that differs from those that are currently available.

### BRIEF DESCRIPTION

In one embodiment, a braking assembly for a vehicle is provided and can include a braking element having an arcuate body. The braking element can include a first lobe extending from the arcuate body and having a first braking surface configured to engage a tread of a wheel, and a first non-braking surface portion adjacent the first lobe configured to not engage the tread of the wheel. The braking element can also include a second lobe extending from the arcuate body that may be spaced and offset from the first lobe, the second lobe having a second braking surface configured to engage the tread of the wheel, and a second non-braking surface portion adjacent the second lobe and diagonal to the first non-braking surface portion, the second non-braking surface portion configured to not engage the tread of the wheel.

In one embodiment, a braking assembly for a vehicle comprising is provided that can include a braking actuator configured to move a braking element from a non-braking position to a braking position. The braking element can be coupled to the braking actuator and include a first lobe having a first braking surface configured to engage a tread of a wheel, and a first non-braking surface portion adjacent the first lobe configured to not engage the tread of the wheel. The braking element can also include a second lobe diagonally fixed from the first lobe, the second lobe having a second braking surface configured to engage the tread of the wheel, and a second non-braking surface portion adjacent the second lobe and diagonal to the first non-braking surface portion, the second non-braking surface portion configured to not engage the tread of the wheel.

In one embodiment, a braking assembly for a vehicle is provided that can include a braking element having an arcuate body. The braking element can include a first lobe extending from the arcuate body on a first side of a longitudinal center axis of the braking element and having a first braking surface configured to engage a tread of a wheel, and a first non-braking surface portion adjacent the first lobe on a second side of the longitudinal center axis of the braking element, the first non-braking surface portion configured to not engage the tread of the wheel. The braking element can also include a second lobe extending from the arcuate body on the second side of the longitudinal center axis of the braking element and having a second braking surface configured to engage the tread of the wheel, and a second non-braking surface portion adjacent the second lobe on the first side of the longitudinal center axis and diagonal to the first non-braking surface portion, the second non-braking surface portion configured to not engage the tread of the wheel.

### BRIEF DESCRIPTION OF THE DRAWINGS

The subject matter may be understood from reading the following description of non-limiting embodiments, with reference to the attached drawings, wherein below:

FIG. 1 illustrates a schematic diagram of a vehicle system.

FIG. 2 illustrates a side plan view that is partially in sectional view of a wheel assembly of a vehicle system.

FIG. 3 illustrates a schematic block diagram of a braking assembly.

FIG. 4 illustrates a perspective view of a braking element of a braking assembly.

FIG. 5 illustrates a perspective view of a braking element of a braking assembly.

FIG. 6 illustrates a perspective view of a braking element of a braking assembly.

FIG. 7A illustrates a schematic diagram of a braking element and tread of a wheel of a vehicle system.

FIG. 7B illustrates a schematic diagram of a braking element and tread of a wheel of a vehicle system.

FIG. 7C illustrates a schematic diagram of a braking element and tread of a wheel of a vehicle system.

FIG. 8A illustrates a top plan view of a braking element of a braking assembly.

FIG. 8B illustrates a top plan view of a braking element of a braking assembly.

FIG. 8C illustrates a top plan view of a braking element of a braking assembly.

FIG. 9A illustrates a graph of changes in radii of a wheel over a length in circumference of the wheel.

FIG. 9B illustrates an infrared image of a tread of a wheel.

FIG. 10A illustrates a graph of a coefficient of friction and temperature over time.

FIG. 10B illustrates a graph of a coefficient of friction and temperature over time.

FIG. 11A illustrates a graph of a coefficient of friction and temperature over time.

FIG. 11B illustrates a graph of a coefficient of friction and temperature over time.

FIG. 12A illustrates a graph of a coefficient of friction and temperature over time.

FIG. 12B illustrates a graph of a coefficient of friction and temperature over time.

FIG. 13A illustrates a graph of a coefficient of friction and temperature over time.

FIG. 13B illustrates a graph of a coefficient of friction and temperature over time.

FIG. 14 illustrates a perspective view of a braking assembly.

FIG. 15 illustrates an elevation view of a braking assembly.

FIG. 16 illustrates a perspective view of a replaceable lobe of a braking element.

FIG. 17 illustrates a perspective view of a replaceable lobe of a braking element.

FIG. 18 illustrates a side plan view of a replacement lobe of a braking element.

### DETAILED DESCRIPTION

Embodiments of the subject matter described herein relate to a brake assembly that uses a brake element having two spaced apart offset (e.g. diagonal to one another) lobes that are used to contact the tread or surface of the wheel. In particular, the diagonal lobes result in a surface divided into four quadrants, two of which are removed to provide the two offset lobes. A spacer is then provided between the offset lobes. The contact face edges of each lobe can be located around the tread center and may be tapered. The tread center can then contact both lobes on the tapered sections of the contact face. The total length of lobe contact in this center section is the same as the contact length of a parallel sided diagonal lobe block. The design feature ensures the center of the tread contacts the block surface with equal length and does not experience zero contact or double length contact with the brake block.

When applied against the tread during braking, each lobe sweeps a different band of the tread surface, typically one band close to the flange of the wheel and one band opposite the flange of the wheel. This allows braking and resulting temperature increases to be more evenly distributed across the wheel tread surface. As a result, there are lower incidences of tread hot spots, fire banding, thermal cracking, spalling, shelling, etc.

The wear volume of the diagonal lobe brake element is also approximately half that of a brake block for the same amount of braking energy. This equates to similar thickness wear rate or similar wear life to a traditional brake block at half the material cost. For the diagonal lobe block element that is mounted on flexible or freely rotating brake equipment, including tread brake units, brake beams, or the like, when the axis of rotation of the block is parallel and offset to the wheel axis of rotation, changes in tread shape or changes in friction element shape due to wear or thermal distortion maintain conformability to each other by the rotation of the diagonal lobe braking element. As a result, the contact area between the tread of the wheel and the friction element is increased compared to brake blocks, allowing sustained full contact area with the tread. This allows better control of contact particularly with thinner wheel treads that undergo more thermal distortion than thick wheel treads. The subsequent wear life of the diagonal lobe brake element under these conditions can be up to five times that of the traditional brake block.

Additionally, the diagonal lobe braking element is chiral (non-superimposable mirror images) and are made as left- or right-handed variants. As the tread surface rotates and meets the leading lobe, the lobe can be located on a flange or rim side of the tread. When combined with a flexible or freely rotating brake block, the leading lobe can be subjected to more force than the trailing lobe against the tread, allowing more braking to occur against the rim or flange side of the tread depending upon which handed diagonal lobe block is chosen and vehicle direction. FIG. 2 shows a centrally located wheel web that connects to the center of the tread and center of the wheel hub. Other wheel geometries can have the web connecting to the flange side or the rim side of the tread. Other wheel geometries can have the web connecting to the inboard or outboard side of the hub.

Typically the flange leading lobe geometry would be selected to allow more braking power to be directed toward the flange side of the tread which has more capacity to absorb brake energy than opposite the flange side of the tread. The flange and wheel web absorb brake energy from the flange side of the tread faster than the rim side of the tread. This results in smaller temperature increases on the flange side of the tread compared to the rim side of the tread. Wheel geometries may be different to that described above where the wheel web may be connected to the rim side of the tread or more heat distribution is available opposite the flange side of the tread. The left or right-handed variant would be chosen to direct braking energy to that part of the wheel tread that can absorb the most amount of braking energy as will be discussed below. Similarly, diagonal lobe blocks could be extended to brake against the flange of the wheel in addition to the tread.

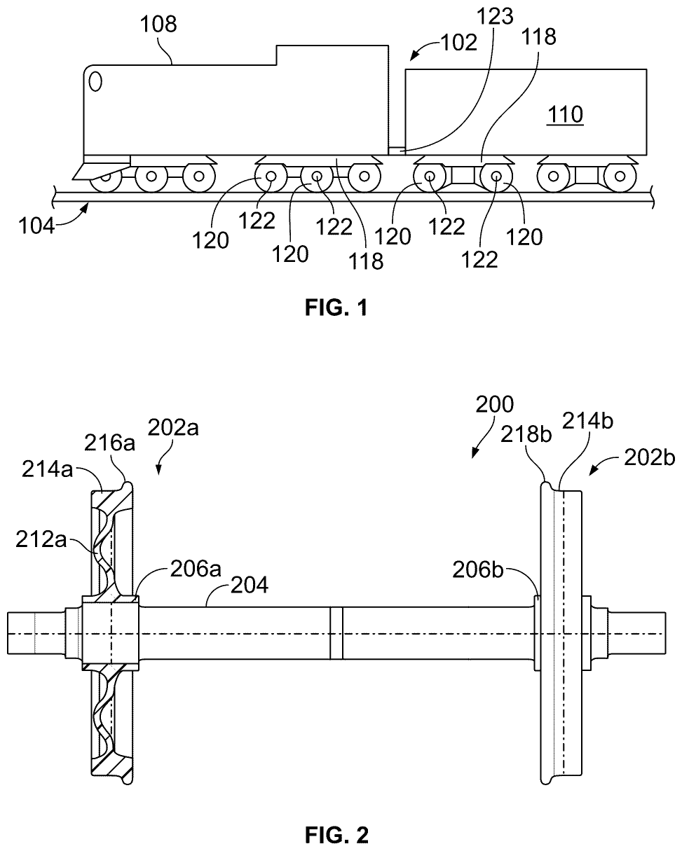

FIG. 1 illustrates a schematic diagram of one example of a vehicle system 100 that includes a control system 102. The vehicle system may travel along a route 104 on a trip from a starting or departure location to a destination or arrival location. The vehicle system includes a propulsion-generating vehicle 108 and a non-propulsion-generating vehicle 110 that are mechanically interconnected to one another to travel together along the route. The vehicle system may include at least one propulsion-generating vehicle and optionally, one or more non-propulsion-generating vehicles. Alternatively, the vehicle system may be formed of only a single propulsion-generating vehicle or multiple propulsion-generating vehicles. The vehicles included in the vehicle system may be mechanically coupled with each other or may be separate (but coordinate movements so that the separate vehicles travel together, such as in a convoy).

The propulsion-generating vehicle may generate tractive efforts to propel (for example, pull or push) the vehicle system along routes. The propulsion-generating vehicle includes a propulsion subsystem, such as an engine, one or more traction motors, and/or the like, which operate to generate tractive effort to propel the vehicle system. Although one propulsion-generating vehicle and one non-propulsion-generating vehicle are shown in FIG. 1, the vehicle system may include multiple propulsion-generating vehicles and/or multiple non-propulsion-generating vehicles. While one or more embodiments are described in connection with a rail vehicle system as illustrated in FIG. 1, not all embodiments are limited to rail vehicle systems. Unless expressly disclaimed or stated otherwise, the subject matter described herein extends to other types of vehicle systems, such as automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers 123) or logically coupled but not mechanically coupled. For example, vehicles may be logically but not mechanically coupled when the separate vehicles communicate with each other to coordinate movements of the vehicles with each other so that the vehicles travel together (e.g., as a convoy).

In the example of FIG. 1, the vehicle includes wheels 120 that engage the route and at least one axle 122 that couples left and right wheels together. Optionally, the wheels and axles are located on one or more trucks or bogies 118. Optionally, the trucks may be fixed-axle trucks, such that the wheels are rotationally fixed to the axles, so the left wheel rotates the same speed, amount, and at the same times as the right wheel. In one embodiment, the vehicle system may not include axles, such as in some mining vehicles, electric vehicles, etc.

The vehicle system may also include a braking assembly that is coupled to at least one of the wheels of the vehicle system. The braking assembly may include a brake disc that is segmented into individual segments to form a friction ring. In one example, the friction ring may consist of only four individual segments with each segment coupled to two other neighboring segments by plural fastening assemblies. Alternatively, the friction ring may be formed of a different number of the segments.

FIG. 2 illustrates an example wheel assembly 200 upon which a braking assembly can be utilized to cause braking of a vehicle system. FIG. 2 is partially illustrated in sectional view to provide additional details related to the wheel assembly. In one example the wheel assembly is part of the vehicle system 100 with the braking assembly of FIG. 1. The wheel assembly includes a first wheel 202a coupled to an axle 204 at a first hub 206a and a second wheel 202b coupled to the axle at a second hub 206b. Each wheel additionally includes a wheel web 212a (the second wheel web is not illustrated) extending from a respective hub to an exterior outer rim 214a, 214b of the respective wheel that engages the track, ground, roadway, surface, or the like. The exterior outer rim of each wheel forms a circular wheel with a continuous arcuate surface. In example embodiments the exterior outer rim includes a tread that is made of a material configured to engage a braking element to allow braking of the wheel while experiencing minimal wear of the material. In particular, the tread represents the friction surface of the wheel with the braking element. In addition, extending from each outer rim is a flange 216a, 216b that similarly can engage the track, ground, roadway, surface, or the like. In operation, the brake assembly described herein engages exterior outer rim of the wheel to provide friction forces to stop the rotation of the wheel, and as a result, the movement of a vehicle system.

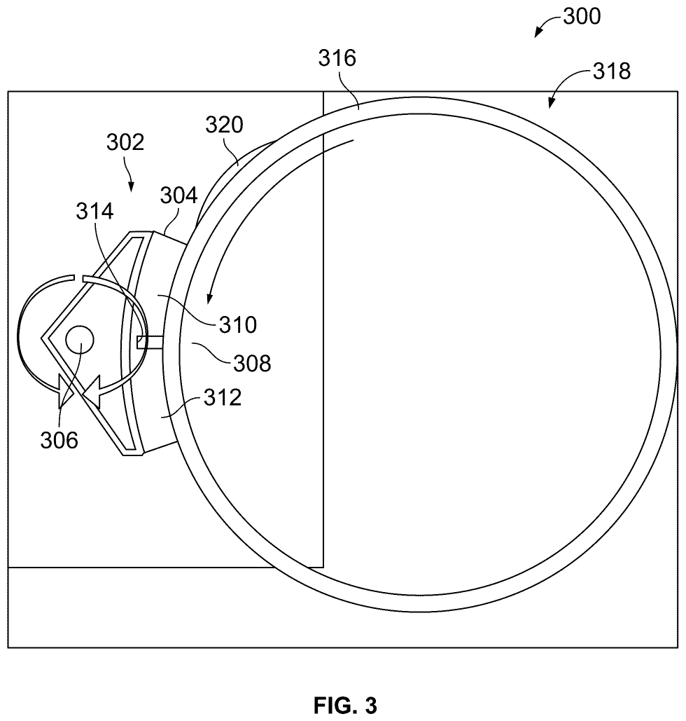

FIG. 3 illustrates a schematic block representation of a braking assembly 300. The braking assembly includes a braking actuator 302 coupled to a braking element 304 that is configured to engage the tread on the exterior outer rim of a wheel. In this example the braking actuator has a generally arcuate body matching the braking element and moves about a pivot pin 306 to provide rotational movement for the braking actuator and braking element. While illustrated in this manner, other braking actuators that are moved and operated in other manners may also be provided. In particular, the braking actuator is configured to couple to the braking element to move the braking element between a braking position and a non-braking position.

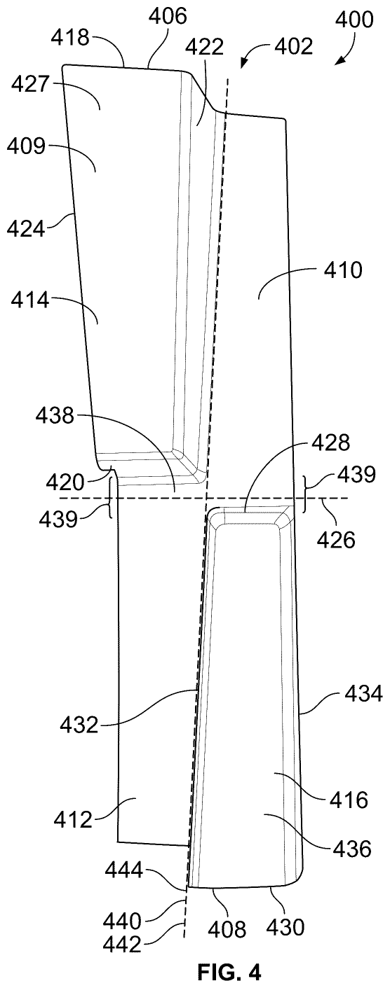

The braking element can include a braking body 308 that is generally arcuate in shape and configured to match the curvature of the wheel. The braking body includes a first lobe 310 and a second lobe 312 that are spaced apart from one another with a spacer 314 that prevents overlapping contact zones on the tread 316 of the wheel 318. The first lobe and second lobe are offset from each other (as illustrated in FIGS. 4-6) and not either aligned or in parallel spaced relation. In one example each of the first lobe and second lobe are tapered from an outside surface of the braking element to an inner surface of the braking element as will be further described herein.

In addition, FIG. 3 illustrates a bump 320 that can sometimes form on the tread of the wheel where the tread surface is temporarily not parallel to the friction element surface. When a block type brake is utilized on the wheel for braking, the block lifts away from the tread next to the bump resulting in reduced braking force. In contrast, the diagonal lobe braking assembly described herein results in the traversing of the bump (irregularity) whilst maintaining tread contact across the entire tread width with both lobes and thus does not cause the reduced braking performance.

FIGS. 4-6 provide numerous examples of braking elements 400 of a braking assembly. The braking elements include an arcuate body 402 shaped to match the circular rim of the wheel. The arcuate body may not be manufactured to match the wheel shape but eventually wears to the wheel shape. The arcuate body extends from a first end 406 to a second end 408 along a curved or arcuate pathway. The arcuate body includes a brake element surface 409 that has a first non-braking surface portion 410 adjacent the first end that faces and extends along the rim of the wheel and is configured to not engage the tread of a wheel. The brake element surface also includes a second non-braking surface portion 412 adjacent the second end that also faces and extends along the rim of the wheel and is also configured not to engage the wheel. Extending from the braking element surface are a first lobe 414 and a second lobe 416.

The first lobe extends from a first lobe end 418 that aligns with the first end of the braking element to a second lobe end 420 that is centrally located between the first end and second end of the braking element. The first lobe end is wider than the second lobe end such that the first lobe tapers from the wider first lobe end to the narrower second lobe end. To this end, the first lobe has an interior face 422 that tapers (extends at an angle) outwardly to become wider, while an exterior face 424 that is opposite to the interior face presents a straight edge. In this manner, the further away from a lateral center axis 426, the wider the first lobe becomes. The first lobe additionally has a first braking surface 427 that is configured to engage the tread on the rim of the wheel. As with the arcuate body, the first braking surface is arcuate to match the curved shape of the wheel. The first braking surface may be formed of a material designed to resist wear while providing friction forces on the tread of the wheel.

The second lobe extends from a second lobe end 428 that is centrally located between the first end and second end of the braking element to a second lobe end 430 that aligns with the second end of the braking element. The first lobe end of the second lobe is wider than the second lobe end of the second lobe such that the second lobe tapers from the wider first lobe end to the narrower second lobe end. To this end, the second lobe has an interior face 432 that tapers outwardly to become wider while an exterior face 434 that is opposite to the interior face presents a straight edge. Because the engaging face tapers the further away from the lateral center axis, the wider the second lobe becomes. The second lobe additionally has a second braking surface 436 that is configured to engage the tread on the rim of the wheel. As with the arcuate body, the second braking surface is arcuate to match the curved shape of the wheel. The first braking surface may be formed of a material designed to resist wear while providing friction forces on the tread of the wheel.

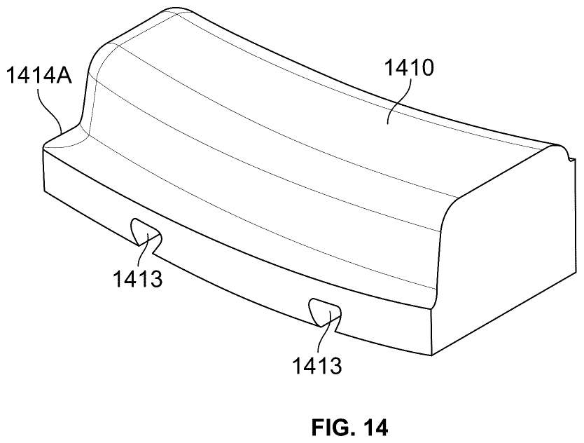

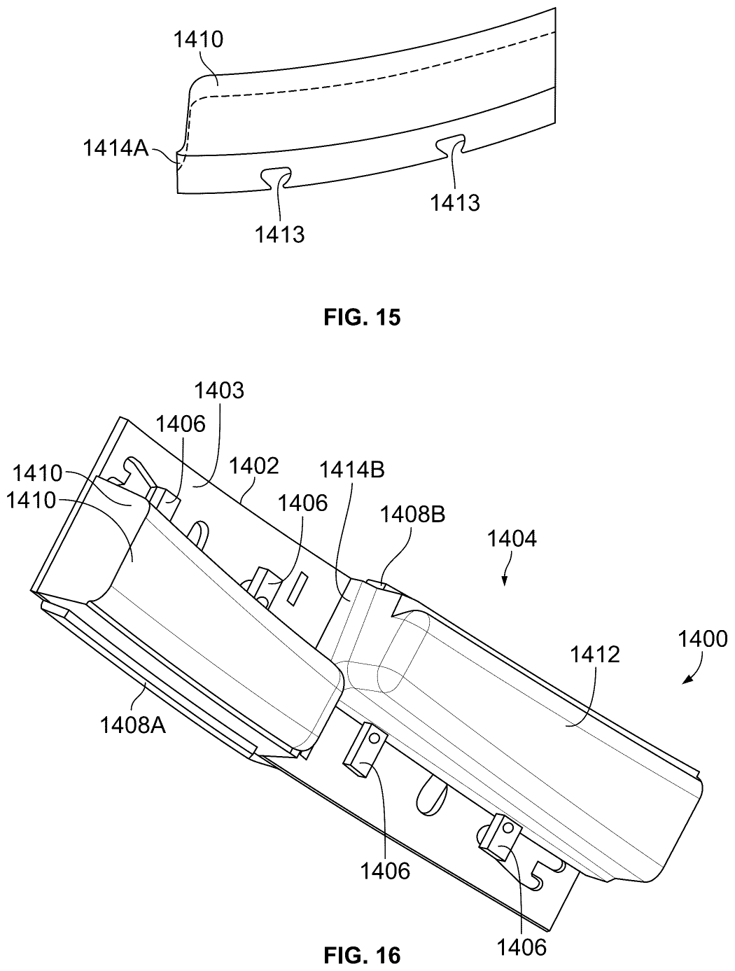

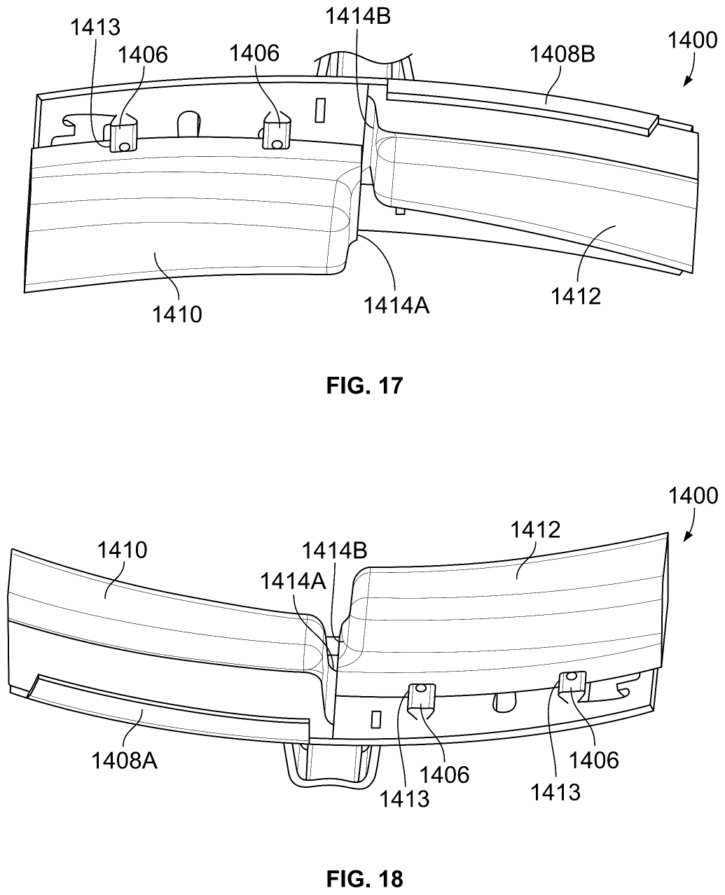

The first lobe and second lobe are spaced from one another with a spacer 438 extending between the first lobe and the second lobe. The spacer in one example can be a portion of the braking element surface extending between the first non-braking surface portion and the second non-braking surface portion as illustrated in FIG. 4. In the embodiment of FIG. 4, the braking element provided is of one-piece construction. In other embodiments the first lobe and second lobe may be detachable (e.g., FIGS. 14-18), and a physical separate spacer may be provided (FIGS. 14-18), or the like. Still, the spacer results in a gap 439, or space, being disposed between the first lobe and the offset second lobe.

The first lobe is also offset from the second lobe. To this end, the first lobe and the second lobe are not aligned with one another and are instead diagonal to one another. In one example, the first lobe is on a first side 440 of a longitudinal center axis 442 of the braking element while the second lobe is on a second side 444 of the longitudinal center axis. Alternatively, some overlapping of the longitudinal center axis may occur for at least one of, if not both of the first lobe and second lobe. In one example the longitudinal center axis may be arcuate. Still, the first lobe is offset from the second lobe when a majority (if not all) of the first lobe is on the first side of the longitudinal center axis while a majority (if not all) of the second lobe is on the opposite, second side of the longitudinal center axis.

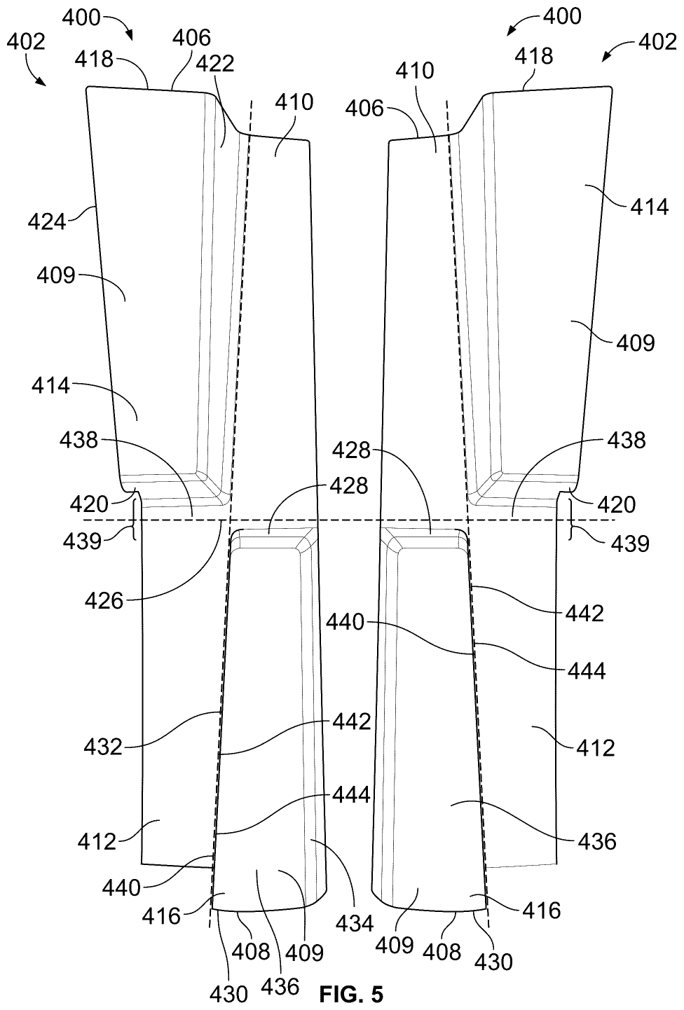

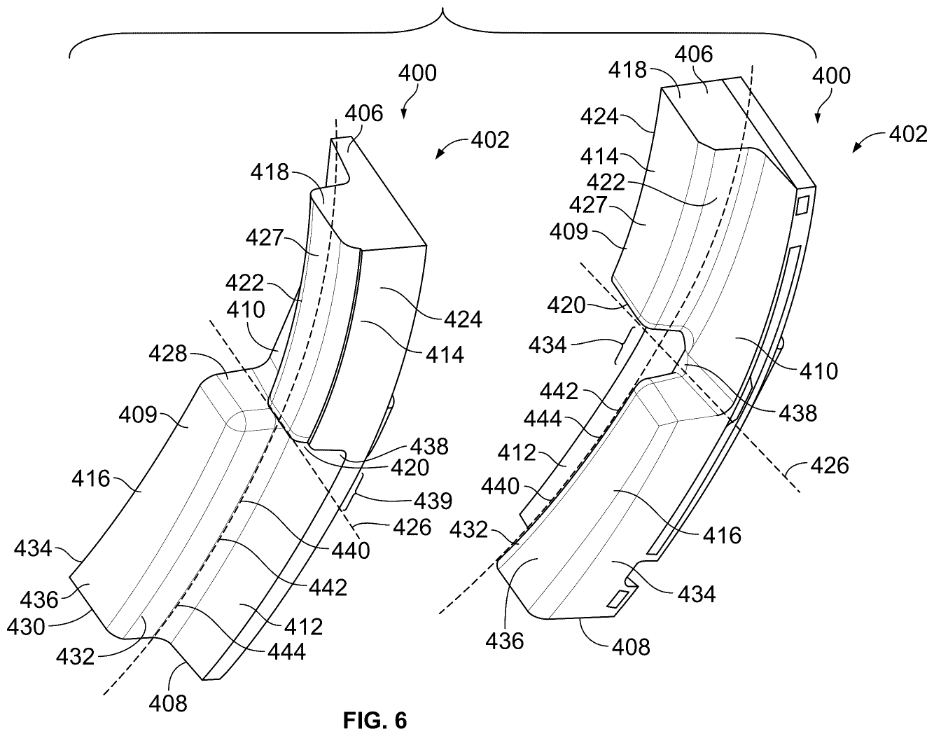

In addition, while FIG. 4 illustrates a righthanded braking lobe, FIGS. 5 and 6 each illustrate examples of righthanded and lefthanded braking lobes respectfully. In particular, torque induced during braking forces the leading lobe to apply more force on the tread than the trailing lobe. Thus, by having both righthanded and lefthanded braking lobes applies to flexible or freely rotating brake headers. In one example, the braking element has a flange leading lobe that biases brake power to the flange side of the tread.

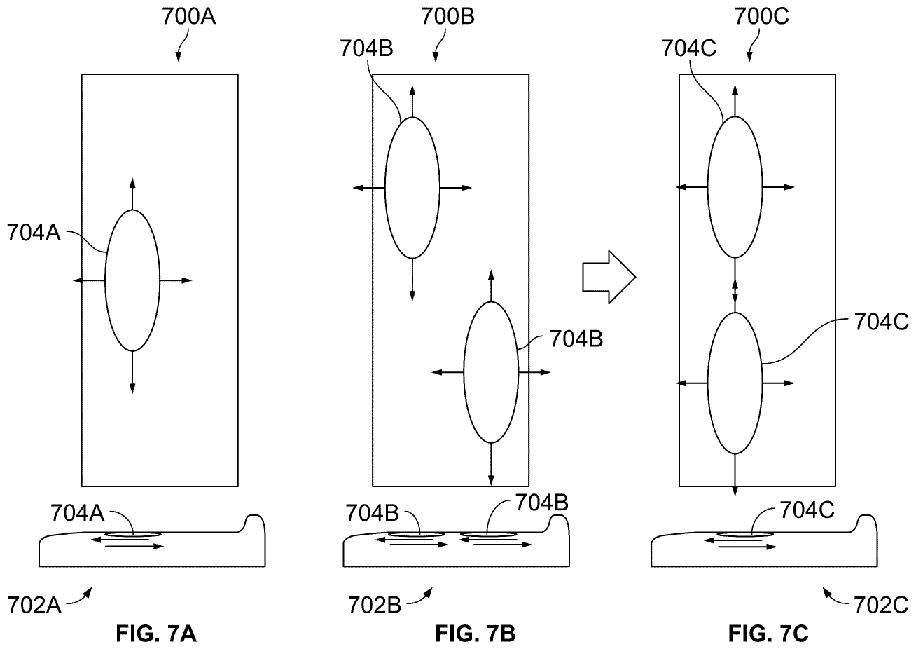

By providing the offset between the first lobe and the second lobe, the first braking surface and the second braking surface engage a larger area of the tread than if aligned. FIGS. 7A-7C illustrate examples treads 700A, 700B, 700C on the corresponding rims 702A, 702B, 702C of wheels. FIG. 7A presents a tread where a braking element having only a single contact is presented. FIG. 7B presents a braking element where two offset contacts are presented as described in relation to FIGS. 3-6. Meanwhile, FIG. 7C illustrates the tread when the braking element has two contacts not offset, but instead align with one another. The constrained or fixed brake block (e.g., lobe) that has the single contact zone (e.g., FIG. 7A) acts on a small section of the wheel tread. Contact zones 704A, 704B, 704C change shape and size and move about the surface depending upon friction material wear and tread shape changes. Overall, the single lobe design of FIG. 7A has a low coefficient of friction, while providing significant wear over time to the same locations. This results in reduced life of the wheel.

When two separate contacts are presented but align as provided in the embodiment of FIG. 7C, a low coefficient of friction remains. This design can occur when freely rotating or flexible brake blocks are provided such as illustrated in FIG. 7B, and the contacts move resulting in alignment. This random alignment again results in poor performance as well, and in particular variable friction behavior.

When offset lobes as provided in the braking elements of FIGS. 3-6 are provided; however, the coefficient of friction increases and is higher than the measured designs of FIGS. 7A and 7C. For example, FIG. 7B illustrates the braking element such as those of FIGS. 3-6 where a first lobe is diagonally fixed (e.g., offset) to a second lobe. This arrangement ensures contact of both lobes with the wheel tread. In particular, the first lobe contacts the tread of the wheel near the flange of the wheel, while the second lobe contacts the tread at a different portion of the rim. Consequently, the contact zones are on different sections of the swept area of the tread, and braking energy is distributed across the tread more than a rectangular block. In addition, because the first lobe and second lobe are diagonally fixed in relation to one another, alignment of contact zones cannot occur.

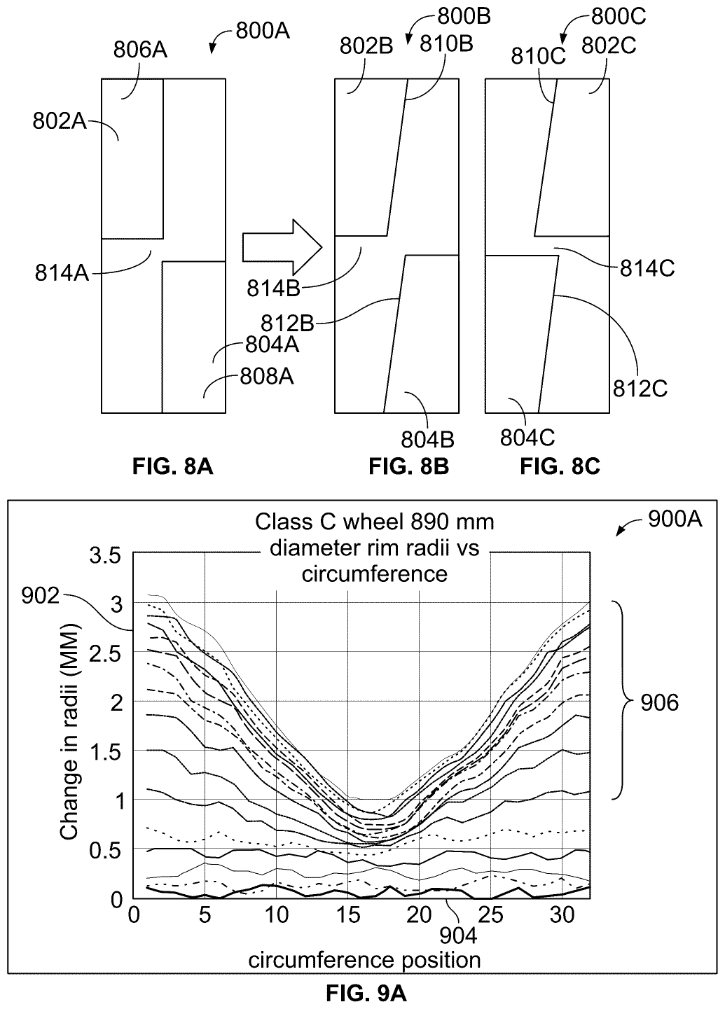

In addition to increasing the coefficient of friction compared to single contact and aligned contact designs, the offset of the first and second lobes along with the tapered shape of each lobe of the braking element of FIGS. 3-6 also results in decreased wear of the tread. As illustrated in FIGS. 8A-8C, the tapered shape of the braking element illustrated in FIGS. 3-6 greatly reduces wear. In particular, FIG. 8A illustrates a braking element 800A that has two parallel lobes 802A and 804A that are offset from one another but are not tapered. Indeed, the first braking surface 806A and second braking surface 808A are rectangular. When each braking surface is rectangular and the lobes are too thin, then a section of the wheel tread is left that does not contact the brake block. Meanwhile, if each lobe is too wide then the centre of the wheel tread would experience double the contact with the lobes resulting in undesired wear.

In contrast, when a brake element 800B, 800C having a first lobe 802B, 802C that is offset from a second lobe 804B, 804C is provided, and each interior surface 810B, 812B, 810C, 812C of the respective lobes is tapered, improved functionality is realized. In particular, the tapered first lobe and tapered second lobe cause the overlapping areas of the lobes to have a reduced surface area compared to rectangular blocks that are too wide. To this end, the lobes can be provided to present more overlap (FIG. 8B) to prevent a section of the wheel tread that does not contact with the lobes. While less overlap (FIG. 8C) provides greater performance, the tapered lobes allow for error during production and alignment error when mounting to braking systems.

In all, the offset and tapered lobes combined with the spacer 814A, 814B, 814C that spaces these lobes to result in better distribution of braking energy across tread. The design ensures contact of both the first and second lobes with the wheel tread. Contact zones are on different sections of the swept area of the tread such that braking energy is distributed across the tread compared to a block braking element. In addition, no alignment of contact zones can occur because the first and second lobe are diagonally fixed in relation to one another. This design also provides more consistent braking power input into each section across tread throughout the entire course of a stop or drag (sustained contact throughout stop). The design also provides smaller temperature gradients across tread during braking and lower peak temperature during braking. The design further provides a more consistent coefficient of friction (COF) under the same braking conditions (average and instantaneous) to block braking elements. To this end, friction under heavy braking is typically at the upper limit of a standard block braking element, while friction under light braking is lower than a standard block braking element (e.g., the COF is less likely to climb or experience over-recovery). This is accomplished with similar static friction. This is accomplished at least half the volume wear of the standard block braking element (e.g., equivalent thickness wear rate), and the design can provide up to 5× (five times) the wear life of the standard block braking element.

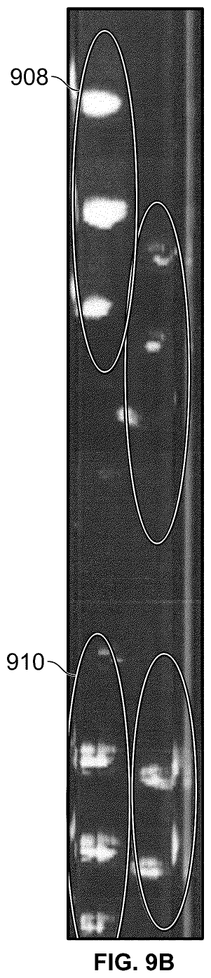

FIGS. 9A-13B illustrate graphs that show many of these advantages. For example, FIG. 9A illustrates a graph 900A and FIG. 9B illustrates an infrared image from testing conducted on block type braking elements that are generally rectangular over the entire braking element surface compared to the braking elements described above in relation to FIGS. 3-6. In particular, the graph of FIG. 9A shows a wheel of a vehicle system undergoing continuous (drag) braking that measures the change in radii of the wheel 902, measured in millimetres (mm) over the length of the circumference 904, measured by different positions on the wheel. More particularly, the graph illustrates a route profile simulation for a standard block braking element for a heavy haul, class C wheel, multiwear 960-890 mm diameter (test wheel at minimum diameter). The drag brake was conducted at 60 kph and at 34-kW. Tread shape measurement was achieved via laser line scan measurement of the wheel tread at 60 kph in 1-minute intervals over 16 minutes. The IR image of FIG. 9B meanwhile presents an IR scanning of the same tread provided immediately after the drag.

For the block type braking elements that are generally rectangular over the entire braking element surface, the end result showed that relaxation of thermal stresses in 890 mm wheels leads to wheel tread distortion, while 960 mm new wheels less distortion occurred but displayed thermal cracking. These block type braking elements 906 all showed a pattern of a U or V shaped curve with greater wear, changes in radii at positions 0-10 and 20-30 than positions 10-20. The average rim radius increases by 2.0 mm while the average flange radius increases by 0.5 mm. A change in conicity was noted in the wheels undergoing the test. The rim out of round (OOR) was +/−1.0 mm, the flange OOR was +/−. 5 mm and the rim crest was 180° out of phase with the flange crest.

The conclusions from reviewing the data related to the block type braking elements was that braking generally occurred on the leading slope of crests. As a result, hot zones developed on the rim side of the tread and 180° out of phase on the flange side of the tread. The pattern of “hot spot” formation 908 (FIG. 9B) can be seen as significant. Subsequent wheel cooling and repeat drag braking creates another deformation out of phase with the original. Hence, a different set of hot spots 910 resulted. The hot spots could also be detected via rim face IR spot measurement. Such hot spots are completely undesirable and can cause tread damage, reducing the life of the wheel and/or increasing the need for repair.

In contrast, the diagonal lobe block braking element (FIG. 9A) as described in FIGS. 3-6 were utilized and unexpected results occurred while decreasing the surface area of the braking surface and materials used. In particular, the diagonal lobe block braking elements showed less distortion and fewer thermal patterns. The rim increased by 1.6 mm radius while the flange also increased by 1.35 mm radius. The rim OOR was +/−0.4 mm while the flange OOR was +/−0.25 mm. In all, hot spots were not detected using the diagonal lobe block braking element.

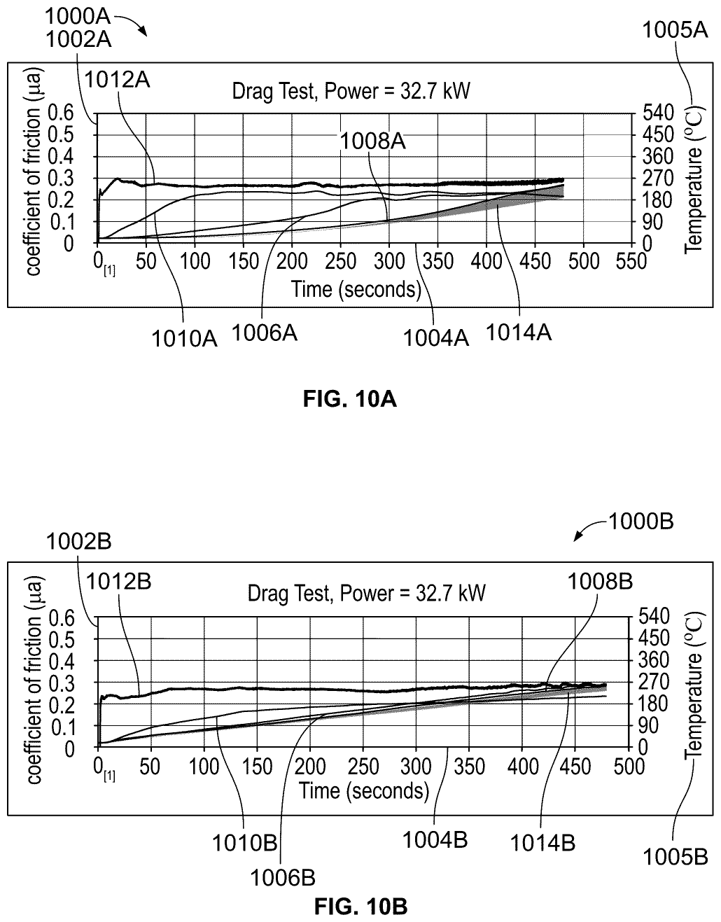

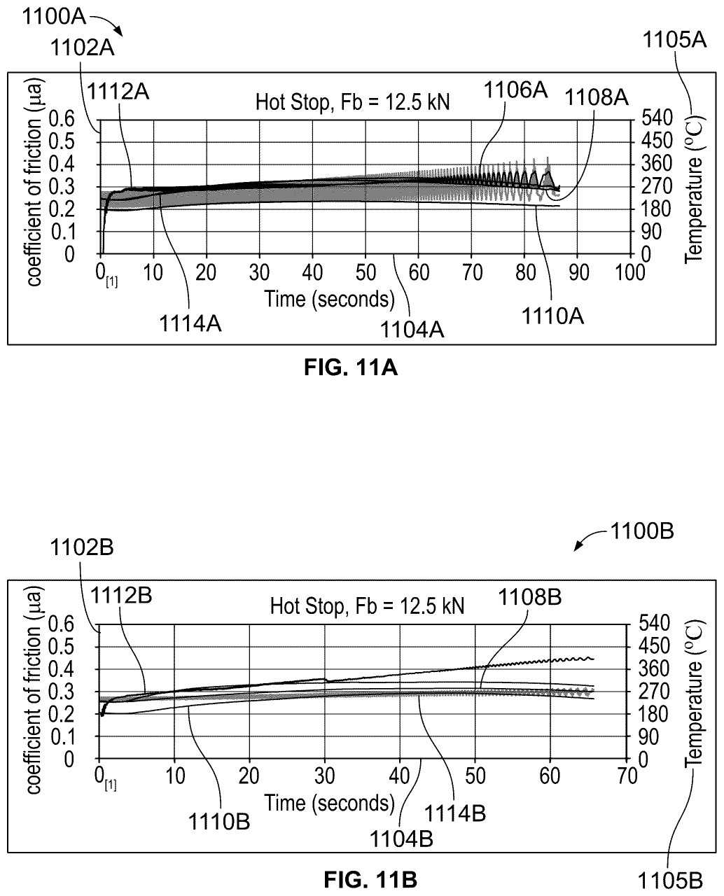

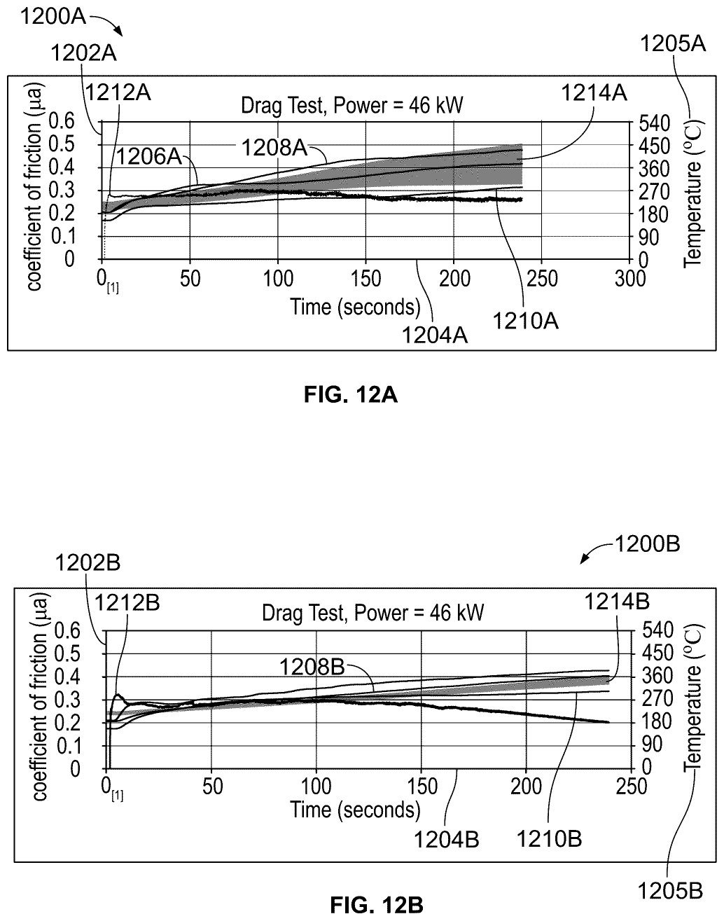

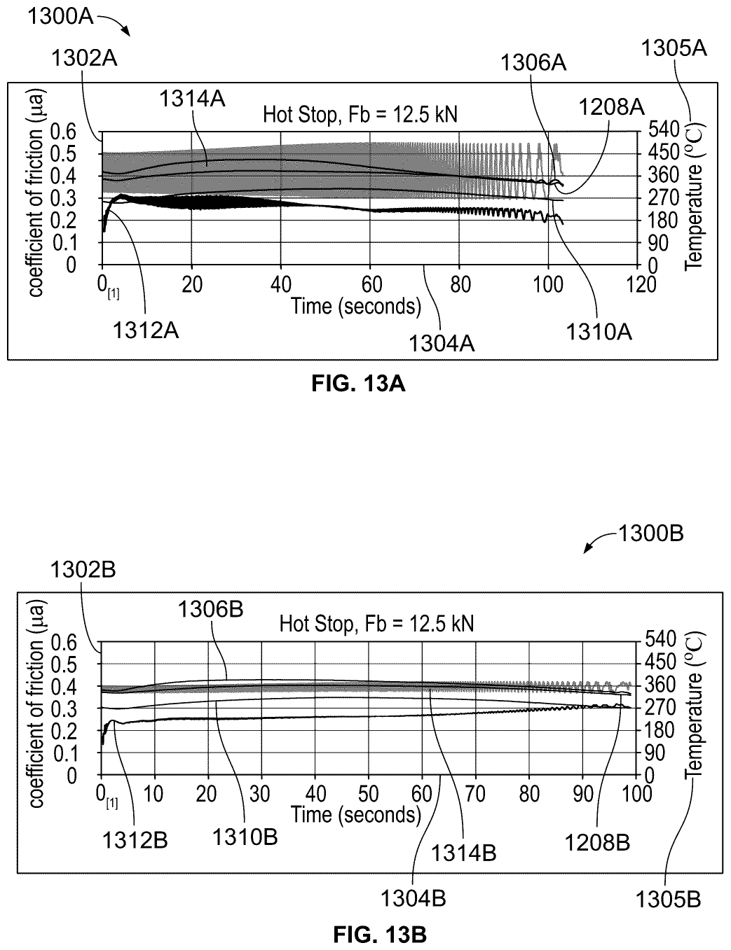

FIGS. 10A-13B illustrate comparative graphs from two different tests (FIGS. 10A-11B illustrating the first test, and FIGS. 12A-13B illustrating the second test). Each Figure illustrates a graphing set with the A Figure illustrating a current block braking element and the B Figure illustrating the diagonal lobe block braking element as illustrated in FIGS. 3-6.

FIGS. 10A, 11A, 12A, 13A and 10B, 11B, 12B, 13B show graphs 1000A, 1100A, 1200A, 1300A and 1000B, 1100B, 1200B, 1300B respectively that compare the coefficient of friction 1002A, 1102A, 1202A, 1302A, 1002B, 110B, 1202B, 1302B over time 1004A, 1104A, 1204A, 1304A, 1004B, 1104B, 1204B, 1304B measured in seconds. Tread temperature was displayed on the secondary Y axis 1005A, 1105A, 1205A, 1305A, 1005B, 1105B, 1205B, 1305B. The measurements were taken using slow response sliding contact thermocouples. Line 1006A, 1106A, 1206A, 1306A, 1006B, 1106B, 1206B, 1306B represents the tire tread temperature at the center of the rim, line 1008A, 1108A, 1208A, 1308A, 1008B, 1108B, 1208B, 1308B represents the tire tread temperature at the rim side of the rim, line 1010A, 1110A, 1210A, 1310A, 1010B, 1110B, 1210B, 1310B represents the tire tread temperature at the flange side of the rim, and line 1012A, 1112A, 1212A, 1312A, 1012B, 1112B, 1212B, 1312B represents tire tread friction, and line 1014A, 1114A, 1214A, 1314A, 1014B, 1114B, 1214B, 1314B represents the tire tread temperature at the rim edge as measured by thermal IR probe to provide fast response and accurate temperature readings for each segment of the wheel circumference. In FIGS. 10A and 10B a drag test was performed at a power of 32.7 kW, in FIGS. 12A and 12B a drag test was performed at a power of 46 kW, while in the FIGS. 11A and 11B and 13A and 13B a hot stop was performed at 12.5 kN.

From a review of the first test, the friction forces are nearly identical to each other despite the diagonal lobe block braking element having significantly less surface area than the block braking element. Meanwhile, each temperature reading of the tire tread rim, center, and flange all increase faster when the block braking element is used compared to the diagonal lobe block. In addition, the tire tread temperature at the rim edge of the block braking element has significantly greater fluctuation and variance as compared to the diagonal lobe block. As a result, not only does the diagonal lobe block braking element have as good as braking performance of the block brake element with less material, but it also has better temperature characteristics resulting in reduced wear on the tread.

FIGS. 14-18 illustrate an alternative embodiment of a braking assembly 1400. In this embodiment the braking assembly includes a braking actuator 1402 that includes a backing plate 1403 for receiving the braking element 1404. The backing plate has an arcuate body that includes one or more male attachment members 1406 along with a first flange 1408A and a second flange 1408B.

In addition, in this embodiment the braking element includes a first lobe 1410 and a second lobe 1412 that are spaced apart and separate from one another. In this manner, each lobe is an individual component that is able to be removed from the backing plate separately for replacement without removal of the other lobe. In particular, each lobe includes corresponding female opening 1413 of size and shape to allow the first and second lobes to be slidably secured to the male attachment members of the backing plate. In one example the female opening may be a dovetail opening. While illustrated with the backing plate having the male attachment members and the lobes having the female openings, these could be reversed. To this end, other mechanical, electrical, magnetic, or the like coupling members may be utilized to replaceably couple the lobes into the backing plate. In addition, the flanges of the backing plate are provided adjacent to each lobe to prevent lateral movement of the lobe during operation.

Each of the first lobe and the second lobe include a spacer 1414A, 1414B to prevent overlapping contact zones on the tread of the wheel. The first lobe and second lobe are offset from each other and not aligned or in parallel spaced relation. In one example each of the first lobe and second lobe are tapered from an outside surface of the braking element to an inner surface of the braking element as will be further described herein. As a result, another embodiment of a diagonal lobe block braking element is provided.

As a result of the replaceable design of the embodiment of FIGS. 14-18, worn friction material can be replaced with new lobe or puck of friction material using dovetail or similar mechanical interface to existing metal backing plate that interfaces with existing brake block holder or directly mounted onto the holder without an intermediate backplate. In addition, different friction materials can be used in each lobe to control how brake power is distributed onto wheel tread, typically more power to the flange side of the tread.

While illustrated as a backing plate 1403 with two lobes 1410, 1412 that are both tapered, spaced, and offset/diagonal from one another, in other example embodiments the first lobe 1410 and second lobe 1412 may be short and narrow brake blocks that are mounted with a diagonal offset on the brake equipment. In yet another example, three or more lobes can also be provided depending on the application to distribute braking energy across the tread in a similar function as a two-lobe design.

In one or more embodiments a braking assembly for a vehicle is provided and can include a braking element having an arcuate body. The braking element can include a first lobe extending from the arcuate body and having a first braking surface configured to engage a tread of a wheel, and a first non-braking surface portion adjacent the first lobe configured to not engage the tread of the wheel. The braking element can also include a second lobe extending from the arcuate body that may be spaced and offset from the first lobe, the second lobe having a second braking surface configured to engage the tread of the wheel, and a second non-braking surface portion adjacent the second lobe and diagonal to the first non-braking surface portion, the second non-braking surface portion configured to not engage the tread of the wheel.

Optionally, the braking element can also include a spacer positioned between the first lobe and the second lobe. In one aspect the first lobe can taper from a first lobe end to a second lobe end such that the first lobe end is wider than the second lobe end, the second lobe end adjacent to a lateral center axis of the braking element. In another aspect, the second lobe may taper from a first lobe end to a second lobe end such that the first lobe end of the second lobe is wider than the second lobe end of the second lobe, the second lobe end of the second lobe adjacent the lateral center axis of the braking element. In one example, the first lobe can be on a first side of a longitudinal center axis of the braking element and the second lobe is on a second side of the longitudinal center axis to provide the offset between the first lobe and the second lobe. In another example a majority of the first lobe may be on a first side of a longitudinal center axis of the braking element and a majority of the second lobe is on a second side of the longitudinal center axis to provide the offset between the first lobe and that second lobe. In one embodiment, the first lobe can be diagonally fixed to the second lobe on the braking element. In another embodiment the braking element can be of one-piece construction. In yet another example, only the first lobe and the second lobe can engage the tread of the wheel during braking.

Optionally the braking assembly can also include a braking actuator configured to couple to the braking element to move the braking element between a braking position and a non-braking position, the braking actuator including a backing plate for receiving the braking element. In one aspect, the backing plate can detachably receive the first lobe and the second lobe so that the first lobe and the second lobe are each replaceable without removing the braking element. In another aspect, the backing plate can include a male attachment member configured to receive a female opening of the first lobe to couple the first lobe to the backing plate. In one example the braking element may include the first lobe having a first spacer and the second lobe having a second spacer.

In one or more embodiments a braking assembly for a vehicle comprising is provided that can include a braking actuator configured to move a braking element from a non-braking position to a braking position. The braking element can be coupled to the braking actuator and include a first lobe having a first braking surface configured to engage a tread of a wheel, and a first non-braking surface portion adjacent the first lobe configured to not engage the tread of the wheel. The braking element can also include a second lobe diagonally fixed from the first lobe, the second lobe having a second braking surface configured to engage the tread of the wheel, and a second non-braking surface portion adjacent the second lobe and diagonal to the first non-braking surface portion, the second non-braking surface portion configured to not engage the tread of the wheel.

Optionally, at least one of the first lobe or the second lobe can have a spacer to position the first lobe in spaced relation to the second lobe. In one aspect, the first lobe can taper from a first lobe end to a second lobe end such that the first lobe end is wider than the second lobe end, the second lobe end adjacent a lateral center axis of the braking element, and the second lobe tapers from a first lobe end to a second lobe end such that the first lobe end of the second lobe is wider than the second lobe end of the second lobe, the second lobe end of the second lobe adjacent the lateral center axis of the braking element. In one example, the braking actuator can include a backing plate configured to detachably receive the first lobe and the second lobe so that the first lobe and the second lobe are each replaceable without removing the braking element. In another example, the backing plate can include a male attachment member configured to receive a female opening of the first lobe to couple the first lobe to the backing plate.

In one or more embodiments a braking assembly for a vehicle is provided that can include a braking element having an arcuate body. The braking element can include a first lobe extending from the arcuate body on a first side of a longitudinal center axis of the braking element and having a first braking surface configured to engage a tread of a wheel, and a first non-braking surface portion adjacent the first lobe on a second side of the longitudinal center axis of the braking element, the first non-braking surface portion configured to not engage the tread of the wheel. The braking element can also include a second lobe extending from the arcuate body on the second side of the longitudinal center axis of the braking element and having a second braking surface configured to engage the tread of the wheel, and a second non-braking surface portion adjacent the second lobe on the first side of the longitudinal center axis and diagonal to the first non-braking surface portion, the second non-braking surface portion configured to not engage the tread of the wheel. Optionally, the braking element can also include a spacer that provides a lateral gap between the first lobe and the second lobe on the arcuate body of the braking element.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

As used herein, an element or step recited in the singular and preceded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following claims, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function devoid of further structure.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A braking assembly for a vehicle comprising:
a braking element having an arcuate body, the braking element comprising:
a first lobe extending from the arcuate body and having a first braking surface configured to engage a tread of a wheel;
a first non-braking surface portion adjacent the first lobe configured to not engage the tread of the wheel;
a second lobe extending from the arcuate body that is spaced and offset from the first lobe, the second lobe having a second braking surface configured to engage the tread of the wheel; and
a second non-braking surface portion adjacent the second lobe and diagonal to the first non-braking surface portion, the second non-braking surface portion configured to not engage the tread of the wheel.

2. The braking assembly of claim 1, wherein the braking element further comprises a spacer positioned between the first lobe and the second lobe.

3. The braking assembly of claim 1, wherein the first lobe tapers from a first lobe end to a second lobe end such that the first lobe end is wider than the second lobe end, the second lobe end adjacent a lateral center axis of the braking element.

4. The braking assembly of claim 3, wherein the second lobe tapers from a first lobe end to a second lobe end such that the first lobe end of the second lobe is wider than the second lobe end of the second lobe, the second lobe end of the second lobe adjacent the lateral center axis of the braking element.

5. The braking assembly of claim 1, wherein the first lobe is on a first side of a longitudinal center axis of the braking element and the second lobe is on a second side of the longitudinal center axis to provide the offset between the first lobe and the second lobe.

6. The braking assembly of claim 1, wherein a majority of the first lobe is on a first side of a longitudinal center axis of the braking element and a majority of the second lobe is on a second side of the longitudinal center axis to provide the offset between the first lobe and that second lobe.

7. The braking assembly of claim 1, wherein the first lobe is diagonally fixed to the second lobe on the braking element.

8. The braking assembly of claim 1, wherein the braking element is of one-piece construction.

9. The braking assembly of claim 1, wherein only the first lobe and the second lobe engage the tread of the wheel during braking.

10. The braking assembly of claim 1, further comprising:
a braking actuator configured to couple to the braking element to move the braking element between a braking position and a non-braking position, the braking actuator including a backing plate for receiving the braking element.

11. The braking assembly of claim 10, wherein the backing plate detachably receives the first lobe and the second lobe so that the first lobe and the second lobe are each replaceable without removing the braking element.

12. The braking assembly of claim 10, wherein the backing plate includes a male attachment member configured to receive a female opening of the first lobe to couple the first lobe to the backing plate.

13. The braking assembly of claim 10, wherein the braking element includes the first lobe having a first spacer and the second lobe having a second spacer.

14. A braking assembly for a vehicle comprising:
a braking actuator configured to move a braking element from a non-braking position to a braking position;
the braking element coupled to the braking actuator and comprising:
a first lobe having a first braking surface configured to engage a tread of a wheel;
a first non-braking surface portion adjacent the first lobe configured to not engage the tread of the wheel;
a second lobe diagonally fixed from the first lobe, the second lobe having a second braking surface configured to engage the tread of the wheel; and
a second non-braking surface portion adjacent the second lobe and diagonal to the first non-braking surface portion, the second non-braking surface portion configured to not engage the tread of the wheel.

15. The braking assembly of claim 14, wherein at least one of the first lobe or the second lobe has a spacer to position the first lobe in spaced relation to the second lobe.

16. The braking assembly of claim 14, wherein the first lobe tapers from a first lobe end to a second lobe end such that the first lobe end is wider than the second lobe end, the second lobe end adjacent a lateral center axis of the braking element, and the second lobe tapers from a first lobe end to a second lobe end such that the first lobe end of the second lobe is wider than the second lobe end of the second lobe, the second lobe end of the second lobe adjacent the lateral center axis of the braking element.

17. The braking assembly of claim 14, wherein the braking actuator includes a backing plate configured to detachably receive the first lobe and the second lobe so that the first lobe and the second lobe are each replaceable without removing the braking element.

18. The braking assembly of claim 17, wherein the backing plate includes a male attachment member configured to receive a female opening of the first lobe to couple the first lobe to the backing plate.

19. A braking assembly for a vehicle comprising:
a braking element having an arcuate body, the braking element comprising:
a first lobe extending from the arcuate body on a first side of a longitudinal center axis of the braking element and having a first braking surface configured to engage a tread of a wheel;
a first non-braking surface portion adjacent the first lobe on a second side of the longitudinal center axis of the braking element, the first non-braking surface portion configured to not engage the tread of the wheel;
a second lobe extending from the arcuate body on the second side of the longitudinal center axis of the braking element and having a second braking surface configured to engage the tread of the wheel; and
a second non-braking surface portion adjacent the second lobe on the first side of the longitudinal center axis and diagonal to the first non-braking surface portion, the second non-braking surface portion configured to not engage the tread of the wheel.

20. The braking assembly of claim 19, wherein the braking element further comprises a spacer that provides a lateral gap between the first lobe and the second lobe on the arcuate body of the braking element.
